(19) United States
(12) Patent Application Publication
(10) Pub. No.: US 2005/0205144 A1
(43) Pub. Date: Sep. 22, 2005

(54) Cartridge retrievable flow control valve

(76) Inventor: Richard L. Rosas, San Antonio, TX (US)

Correspondence Address: DUANE, MORRIS, LLP, 3200 SOUTHWEST FREEWAY, SUITE 3150, HOUSTON, TX, 77027, US

(21) Appl. No.: 10/803,425

(22) Filed: Mar. 18, 2004

(51) Int. Cl. F16K 11/074

(52) U.S. Cl. 137/625.31

(57) ABSTRACT

A flow control valve has a fixed orifice adjacent to a movable orifice. The fixed orifice is secured to a cage that is in turn secured to a bonnet. This allows the fixed and movable disc to be simply installed and removed from the body through the bonnet. The stem assembly features a forked member for a strong grip of the movable disc. The design removes the need for precision machining bores in the body and facilitates assembly or removal of the valve internals.

### FIELD OF THE INVENTION

The field of this invention relates to flow control valves where the internals can selectively be removed or inserted separately or as unit through a cover bonnet.

### BACKGROUND OF THE INVENTION

Flow control valves come in a variety of designs. One common design involves relative movement between a stationary orifice and a movable orifice which results in variation of the pressure drop across the valve body with the resulting required flow or pressure or some other type of control. The valve body can take all the pressure drop resulting from such relative movement in one or more stages, with each stage of pressure drop created by a discrete pair of stationary and movable orifice. Illustrative of a relevant design to the present invention is U.S. Pat. No. 5,365,978 showing a top entry valve with two sets of orifices. There is a pair of discs in the body closest to the outlet representing the second stage of pressure reduction in the valve body. The stationary disc 16 is held to the body wear insert 14A in FIG. 8 and the wear insert itself is held to body 12A by pins 154 that extend into machined holes in the body 12. The stem assembly 72 has a pair of opposed tabs 166 at its lower end that can be placed under tabs 200 of the wear sleeve 14A as shown in FIG. 15. Alternatively the stem assembly 72 can have a thread 246 shown in FIG. 18 that, when desired, can be moved to engage a mating thread 248 on wear sleeve 14B, as shown in FIG. 19. A pin or pins 70 extend from the lower end of the stem assembly 72 to engage the movable disc 18 for selective alignment or misalignment of orifices 54 with stationary orifices 44. A related reference to this patent is U.S. Pat. No. 5,217,046. One of the objectives of the prior designs was to allow the stationary disc 16 to be removed together with the stem assembly. U.S. Pat. No. 5,365,978 offered two ways to do this. In essence the wear sleeve had to be selectively engaged by stem assembly so that with the bonnet removed, the stationary disc and the wear sleeve would come out together. In both proposed solutions the stem assembly needed to be manipulated to catch the wear sleeve. One way was with a selectively engaging thread and the other was a bayonet style where opposed tabs had to be driven past another set of opposed tabs on the wear sleeve, then turned 90 degrees to make the tabs align so that an upward pull on the stem assembly would bring out with it the wear sleeve and the stationary disc within the wear sleeve.

The problems with these solutions require a more precise machining of all the components to limit the axial travel of the valve internals in both the pressurized and non-pressurized conditions. At pressurized conditions, which would create a separating force on the internals, if the tolerance of the internals is not tight enough, it is possible for the tabs to incorrectly be located on the same plane. Under these binding conditions, it is possible to be unable to control the opening of the valve, possibly resulting in the damage of the stem or actuator.

The threaded configuration design, FIG. 27 of U.S. Pat. No. 5,365,978, would inherently create a thread pitch in travel from the wear sleeve relative to the stem per rotation of the stem. The wear sleeve could dislodge from securing pins, Items 154 of FIG. 20 of U.S. Pat. No. 5,365,978, from excessive travel, thus giving rise to an uncontrollable valve.

There were other problems inherent to the design of the prior art described above. The need to place with precision the bores in the body to accept pins 154 shown in U.S. Pat. No. 5,365,978 added considerably to the manufacturing cost of the valve shown. In addition to the considerable manufacturing cost, is the alignment difficulty of properly installing the sleeve into the valve body. Additionally the movable disc 18 was driven by a pair of pins 70 that extended from the lower end of the stem assembly 72. The movable disc is prone to vibrate back and forth at high frequency, also known as chatter, during certain flow conditions and disc positioning. The chatter would cause a potential for undue wear on the minimal connecting pair of pins 70. The failure of these pins would result in the inability to drive the disc 18, thus creating an uncontrollable valve, which would require a system shutdown or a system bypassing of the valve so that it could be disassembled and repaired.

The present invention allows the cage that supports the fixed disc to be supported against rotation and for insertion or removal from the bonnet. It eliminates the need for precision machining of small bores in the body. The movable disc is operated by a drive fork as part of the stem assembly to increase reliability of that connection and further reduce manufacturing cost. The increased area of engagement between the controllable disc and the fork will prolong the life in an environment prone to chatter. The fixed disc is preferably secured to the cage using a Woodruff type key. The entire assembly is now simply installed or removed from the body and the problems of stem chatter and uncertainties of capturing the assembly holding the fixed disc are reduced. These and other advantages of the preferred embodiment of the invention will be more readily apparent to those skilled in the art from the description of the preferred embodiment, which appears below and from the appended claims that indicate the broad range of the invention.

### SUMMARY OF THE INVENTION

A flow control valve has a fixed orifice adjacent to a movable orifice. The fixed orifice is secured to a cage that is in turn secured to a bonnet. This allows the fixed and movable disc to be simply installed and removed from the body through the bonnet. The stem assembly features a forked member for a strong grip of the movable disc. The design removes the need for precision machining bores in the body and facilitates assembly or removal of the valve internals.

### BRIEF DESCRIPTION OF THE DRAWINGS

FIG. 1 is a section view through a valve showing the arrangement of the components;

FIG. 2 is an exploded view of the valve internals in FIG. 1.

### DETAILED DESCRIPTION OF THE PREFERRED EMBODIMENT

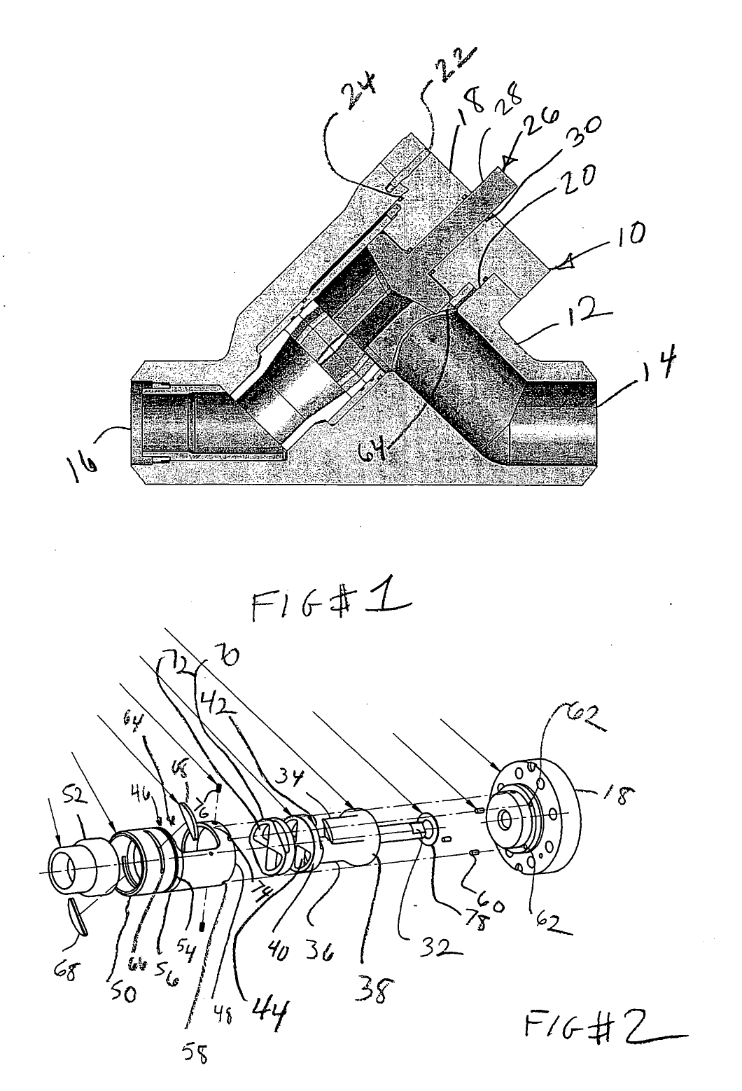

Referring to FIG. 1, the valve 10 has a body 12 with an inlet 14 and an outlet 16. A bonnet 18 closes off the top entrance 20 with a series of bolts (not shown) guided by pin 22 for initial alignment and a seal 24. A stem assembly 26 comprises a shaft 28 that extends through bonnet 18 with a seal 30 surrounding it. An operator such as a hand wheel or valve actuator (not shown) can be secured to the shaft 28 outside of bonnet 18 to operate the valve 10. One or more flats 32 can be located at the end of shaft 28 to facilitate attachment of a hand wheel or actuator, as shown in FIG. 2.

A pair of longitudinally extending members 34 and 36, preferably located 180° apart extend from a hub 38 connected to the lower end of shaft 28. Movable orifice disc 40 has a pair of cutouts, one of which 42 can be seen in FIG. 2. The extending members 34 and 36 go into the cutouts 42 so that rotation of the shaft 28 results in rotation of the movable disc 40 and the one or more orifices 44 that extend through it.

A cage 46 has an upper end 48 and a lower end 50. A cage insert 52 is secured near lower end 50. An exterior groove 54 holds a seal 56 to seal against the body 12. The upper end 48 featured slots 58 into which pins 60, that are mounted to bonnet 18, extend. Pins 60 are secured in bores 62 in bonnet 18. Cage 46 has an opening 64 that aligns with inlet 14 to allow inlet flow through cage 46 to reach orifices 44 in movable disc 40.

One or more slots 66 are located through the wall of cage 46 to allow on or more Woodruff keys 68 to extend into or adjacent stationary disc 70 that has one or more orifices 72. Additionally, cage 46 has openings 74 to accept screws 76 to extend into bonnet 18.

A thrust bearing 78 reduces the torsional load to operate stem 28 and braces the hub 38 with the bonnet 18. This bonnet 18 is secured to body 12 with bolts (not shown) using guide 22 for initial alignment. Longitudinal motion is prevented upon assembly to minimize chatter of the shaft 28.

Those skilled in the art can now readily appreciate some of the advantages of the illustrated preferred embodiment of the invention. The cage 46 secures the stationary disc 70 in the body 12 without having to precision machine bores in the body to locate pins to hold the stationary disc in position as in the past in U.S. Pat. No. 5,365,978. Instead pins 60 prevent rotation of the cage 46 and those pins extend from the bonnet. Additionally the fixed disc 70 is secured to the cage 46 through openings 66 in the cage. Again the placement of the fixed disc 70 requires no precise machining on body 12, as in the past. The fixed disc 70 can be secured to the cage 46 in a manner that permits replacement when the valve 10 is disassembled. Unlike the prior designs there is no built in axial play required in the present invention as screws 76 provide a releasable connection to the bonnet 18 directly. The uncertainty of bayonet style or threaded component engagement required for retrieval of the fixed disc in the prior design is eliminated. The risk of chatter failure is greatly reduced. The expensive electrical discharge machining process on the body 12 of valve 10 is no longer required. The movable disc 40 is driven by the robust extending members 34 and 36 instead of the more flimsy pins, as in the prior design. As a result, the present invention allows the valve 10 to be manufactured more cheaply and facilitates assembly and disassembly. While a single stage pressure reduction is illustrated in the preferred embodiment, those skilled in the art will appreciate that a multistage configuration can be easily adapted to have the desirable features of the present invention. For example, the body 12 can include another fixed orifice adjacent inlet 14 and the opening 64 in cage 46 can feature a mating orifice that can be brought into and out of alignment with the fixed orifice in body 12 as the shaft 28 is rotated.

While a Woodruff key or keys are illustrated, the fixed disc 70 can be held to cage 46 in a variety of equivalent ways such as by pins or snap rings or other types of fasteners, without departing from the scope of the invention.

The foregoing disclosure and description of the invention are illustrative and explanatory thereof, and various changes in the size, shape and materials, as well as in the details of the illustrated construction, may be made without departing from the scope of the invention.

1. A valve, comprising:
a body having an inlet an outlet and a bonnet covering an access opening;
at least two orifice members mounted in said body for relative movement between them;
at least one of said orifice members secured to said bonnet to facilitate at least one of mounting and removal of said orifice in tandem with said bonnet.

2. The valve of claim 1, wherein:
one of said orifice members is stationary and supported by said bonnet.

3. The valve of claim 2, further comprising:
a cage secured to said bonnet to support said stationary orifice member.

4. The valve of claim 3, wherein:
said stationary member is secured to said cage against any movement.

5. The valve of claim 4, wherein:
said stationary member is secured to said cage through an opening in said cage.

6. The valve of claim 5, wherein:
a Woodruff key extends through said opening to secure said stationary member to said cage.

7. The valve of claim 3, wherein:
said cage further comprises at least one recess near an upper end and said bonnet comprises a first extending member engageable to said recess when said bonnet is mounted to said access opening.

8. The valve of claim 7, wherein:
said cage further comprises a longitudinal axis and at least one lateral opening to accept a second extending member that extends into said bonnet.

9. The valve of claim 3, wherein:
one of said orifice members is moveable and supported by said cage.

10. The valve of claim 9, further comprising:
said movable orifice member comprises a disc shape having at least one recess defined adjacent a periphery thereof;
a stem assembly sealably extending through said bonnet and comprising an extending member engaging said recess to turn said movable orifice member.

11. The valve of claim 10, wherein:
said extending member has a longitudinal axis and a generally rectangular cross section in a plane perpendicular to said longitudinal axis.

12. The valve of claim 10, wherein:
said extending member has an outer surface that conforms to the periphery of said movable orifice member when inserted in said recess adjacent the periphery of said movable orifice member.

13. A valve, comprising:
a body having an inlet an outlet and a bonnet covering an access opening;
at least two orifice members mounted in said body for relative movement between them;
one of said orifice members comprises a disc shape having at least one recess defined adjacent a periphery thereof;
a stem assembly sealably extending through said bonnet and comprising an extending member engaging said recess to turn said movable orifice member.

14. The valve of claim 13, wherein:
said extending member has a longitudinal axis and a generally rectangular cross section in a plane perpendicular to said longitudinal axis.

15. The valve of claim 13, wherein:
said extending member has an outer surface that conforms to the periphery of said movable orifice member when inserted in said recess adjacent the periphery of said movable orifice member.

16. The valve of claim 13, wherein:
said bonnet retains said stem assembly against translation along a longitudinal axis thereof.

17. The valve of claim 13, wherein:
at least one of said orifice members secured to said bonnet to facilitate at least one of mounting and removal of said orifice in tandem with said bonnet.

18. The valve of claim 17, further comprising:
one of said orifice members is stationary and supported by said bonnet;
a cage secured to said bonnet to support said stationary orifice member.

19. The valve of claim 18, further comprising:
said stationary member is secured to said cage against any movement. said stationary member is secured to said cage through an opening in said cage.

20. The valve of claim 19, further comprising:
said cage further comprises at least one recess near an upper end and said bonnet comprises a first extending member engageable to said recess when said bonnet is mounted to said access opening,
said cage further comprises a longitudinal axis and at least one lateral opening to accept a second extending member that extends into said bonnet.
